(19) United States
(12) Patent Application Publication
(10) Pub. No.: US 2006/0011449 A1
(43) Pub. Date: Jan. 19, 2006

(54) Note, reading apparatus and note identification system

(76) Inventor: Bernhard Knoll, Neubiberg (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/167,839

(22) Filed: Jun. 27, 2005

(30) Foreign Application Priority Data
Jun. 28, 2004 (DE) 10 2004 031 118.8

(51) Int. Cl. G05G 1/00; G07F 1/06

(52) U.S. Cl. 194/214

(57) ABSTRACT

The invention relates to a note having a support element with the flexibility of paper, having an electronic chip on and/or in the support element, having a circuit monolithically integrated in the chip and having a field coupling element which is monolithically integrated in the chip, which is set up to interact with an electromagnetic field and which is coupled to the integrated circuit.

The invention relates to a note, to a reading apparatus and to a note identification system.

To improve the security of banknotes, it is possible to provide electronic chips in such a banknote. Suitable applications are the authenticity check at banks (particularly at a central bank), and especially improving and simplifying the authenticity check in businesses, particularly in businesses in the retail trade.

On the basis of the prior art, retail businesses perform an authenticity check on a banknote by irradiating the banknote with UV light. This method is not sufficiently secure against forgery, however, and is therefore a high security risk.

[1] discloses a banknote which has a transponder chip containing data for the monetary value and the registration number of the respective banknote. The transponder chip from [1] is equipped with a conventional macroscopic antenna coil into which electromagnetic radiation can be coupled in order to read information stored in the chip.

However, the banknote known from [1] is expensive to produce, since the conventionally manufactured transponder chip is cost-intensive on account of its large surface area and on account of the high cost involvement for forming the antenna.

[2] discloses a note having at least one semiconductor chip and a capacitive antenna which is connected to the semiconductor chip, the antenna overlapping a conductive layer on the note in order to increase the coupling capacitance.

[3] discloses a banknote having an electric circuit which is arranged on or in the banknote and which can send or receive information.

[4] discloses a security paper which has a coated foil-like support embedded in it, the support having electronic circuits and antennas.

The invention is based on the problem of providing a note which can be produced inexpensively while having a high level of security against forgery.

The problem is solved by a note, by a reading apparatus for reading information contained in an electronic chip on a note and by a note identification system having the features based on the independent patent claims.

The inventive note contains a support element with the flexibility of paper and an electronic chip on and/or in the support element, and also a circuit monolithically integrated in the chip and a field coupling element which is monolithically integrated in the chip, which is set up to interact with an electromagnetic field and which is coupled to the integrated circuit.

The inventive reading apparatus for reading information contained in an electronic chip on a note contains a holding device for holding the note and an electromagnetic radiation source for emitting electromagnetic radiation to a field coupling element on the note, which field coupling element is monolithically integrated in the chip on the note. In addition, the reading apparatus contains a detection device for detecting an electromagnetic signal emitted by the field coupling element on the note and an ascertainment device for ascertaining information contained in the chip on the note from the electromagnetic signal emitted by the field coupling element on the note.

In addition, the invention provides a note identification system which has a note having the features described above and a reading apparatus having the features described above for reading information contained in an electronic chip on the note.

A basic idea of the invention can be seen as being to provide an electronically readable note, whose central piece is an electronic chip on and/or in a mechanically flexible supple paper support element, with a circuit and a field coupling element (clearly an antenna) in fully monolithically integrated form in the chip. On account of the miniaturized manufacturability of the chip, which can be manufactured particularly using silicon microtechnology, provision can be made for the required chip surface area to be very small. This means that the invention makes it possible to produce an inexpensive note in the region of one Euro cent. With typical production costs for a banknote of ten Euro cents, the inventive note is thus a competitive solution to the problem of electronically readable notes. In comparison with the known authenticity check based on UV light, the inventive note permits improved security against forgery.

The invention provides a quick and reliable method for detecting the authenticity of notes, e.g. banknotes. In line with one preferred refinement, an electronically readable chip is implemented in a banknote.

To match the implementation of the chip in the note, a reading apparatus is provided for reading such a chip using electromagnetic communication between the field coupling element on the note, i.e. a device for interacting with an external electromagnetic field, and the reading apparatus.

During manufacture of the note, the support element with the flexibility of paper is produced using a paper production method, and an identification chip is also incorporated into the paper. The chip can be encased with a protective shell beforehand. Following production of the banknote, the chip can have information read from it and possibly written to it using the inventive reading apparatus, e.g. using high frequency (HF) or ultra high frequency (UHF). Data which can be stored in the chip (e.g. a serial number for a banknote and/or for the chip, a value for a banknote, a security code, etc.) improve the authenticity check on the banknote.

Since the inventive chip is preferably contained in the support element with the flexibility of paper, i.e. in a pliable paper material, a sufficiently high level of insulation between the chip and the surroundings is made possible. Electric power can be coupled into the note, particularly by capacitive or inductive means.

Preferred developments of the invention can be found in the dependent claims.

In the inventive note, the field coupling element may be an antenna. The field coupling element refers particularly to an element which can be used to produce electromagnetic coupling to an external electromagnetic field, i.e. an element which can interact or communicate with such an external electromagnetic field.

Clearly, an antenna can be regarded as an electromagnetic LC arrangement in particular, i.e. as a type of electromagnetic resonant circuit. The antenna may be inductance-dominated or capacitance-dominated, depending on whether the dominating influential variable in the LC element is the capacitance C or the inductance L of the antenna.

In the case of the note, the field coupling element can be set up for capacitive interaction with an electromagnetic field. Expressed in another way, the field coupling element can be used to couple an electromagnetic field and the associated power into the chip using capacitor coupling, for example between an electrode on the field coupling element and an external electrode on a reader.

The field coupling element can have a first metalized region for capacitive interaction with an electromagnetic field. Clearly, such a first metalized region can form one plate of a capacitor which is used to provide the capacitive interaction. The second plate of the capacitor can then be implemented using a reading apparatus based on the invention.

The first metalized region can be formed either on the top or on the bottom of the chip.

The top of the chip can be defined particularly as that side of the chip on or in which an integrated circuit is formed, i.e. which side is processed (particularly using semiconductor technology). The back or bottom of the chip is thus that side of the chip which is opposite the processed side of the chip.

In the case of the note, the field coupling element can have a second metalized region, which is electrically decoupled from the first metalized region, for capacitive interaction with an electromagnetic field.

This second metalized region may be provided on the same side of the chip as the first metalized region. In line with this refinement, it is possible, by way of example, for both the first metalized region and the second metalized region to be provided on the front or on the back of the chip and to be arranged at a prescribed distance from one another, for example, next to one another. Possible unwanted interactions between the two metalized regions can be eliminated by providing appropriate field shielding or by providing the metalized regions at a sufficiently great distance from one another.

As an alternative to the refinement described, the second metalized region can be provided on the opposite side of the chip from the first metalized region. In line with this refinement, by way of example, the first metalized region can be formed on the front of the chip and the second metalized region can be formed on the back of the chip, or vice versa. Unwanted interaction between the two metalized regions is thus avoided on account of the sufficiently great distance between the two metalized regions and on account of the interposed chip material.

In the case of the note, the field coupling element can be set up (as an alternative to or in addition to the capacitive coupling described) for inductive interaction with an electromagnetic field.

The field coupling element can have a metalized region for inductive interaction with an electromagnetic field. In line with this refinement, the chip communicates with a reader, for example, by means of coil coupling, so that the reader is provided with a reading coil in this case. The communication element used on the note in line with this refinement is a coil, preferably integrated on the chip, which may be in the form of a planar coil in spiral form, for example. A vertical coil arrangement is also possible.

The metalized region can thus be formed as an inductance on one side of the chip, preferably on the front or on the back of the chip.

The integrated circuit can have a memory device. The memory device can be used to store data.

The memory device may be a nonvolatile memory device.

In particular, the memory device may be a rewritable memory device (e.g. an EEPROM, “electrically erasable and programmable read only memory”) or a write-once memory device (e.g. an OTP “one time programmable memory”).

The memory device can store at least one of the following pieces of information: a serial number for the note, a value for the note or a security code. By means of communication between the note and the reader, a reader can thus read a serial number for the note, for example, and in this way perform an authenticity check on the note. However, it is also possible for communication to take place in the opposite direction, i.e. for the reader to program information into the memory device on the note. Thus, by way of example, a monetary value account which is coded in the form of encrypted data on the note, may have a prescribed sum of money debited from it by the reading apparatus.

The integrated circuit may have at least one of the following components: a cryptography module, a rectifier circuit or a load modulator circuit. The functionality of the integrated circuit is almost arbitrary and can be tailored specifically to a given application. The fact that the inventive note can be provided in miniaturized form means that said components can be implemented as integrated circuit components and hence with a very small surface area requirement. A cryptography module can be used to increase security. A rectifier circuit can be provided in order to convert an input-coupled AC voltage on chip into a DC voltage which can be used to supply power to components on the integrated circuit (e.g. a memory device).

The note can be set up as a banknote, as a ticket, as a ski pass, as betting slip, as a share, or as a bill, for example. In these applications, a high level of security against forgery is particularly advantageous.

The text below describes refinements of the inventive reading apparatus for reading information contained in an electronic chip on a note. Refinements of the reading apparatus also apply to the inventive note, which interacts with the reading apparatus, and vice versa.

The inventive reading apparatus can be provided with a reading electrode and a ground electrode which can have the field coupling element on the note inserted between them. In line with this configuration of the reading apparatus, it is possible for capacitive field coupling elements, in particular, to interact with the reading apparatus by virtue of a respective metalized layer on the note and one of the two electrodes of the reading apparatus clearly forming a capacitor, which allows capacitive coupling of electromagnetic energy into the note.

As an alternative or in addition, the reading apparatus may have a reading coil in whose surrounding area it is possible to place the note's field coupling element. In line with this refinement, it is possible for, in particular, a note with an inductive field coupling element to be read by utilizing inductive electromagnetic coupling between an integrated coil on the note and the reading coil.

The electromagnetic radiation source can be set up to emit electromagnetic radiation in the high frequency range or in the ultra high frequency range. In principle, the frequencies used can be chosen arbitrarily, provided that the voltages which then need to be applied to the electrodes for the purposes of reading do not become so high and provided that the frequency intervals used do not overlap frequency intervals which are reserved elsewhere. However, the locally very restricted provision of this electromagnetic radiation, which is limited to the region of a reading apparatus, means that it is also possible to operate at frequencies which are actually reserved for other applications. It is then necessary to prevent the radiation from leaving a surrounding area around the note and the reading apparatus, e.g. using shielding.

The refinements of the reading apparatus and of the note also apply to the note identification system.

In summary, the invention implements a note and a reader very inexpensively, because it can be done in miniaturized form. It should be noted that the invention also provides a note whose chip is encased by an electrically insulating encapsulation, with the field coupling element being provided outside of the encapsulation.

A chip based on the invention may have a thickness of 40 μm and a chip size of 0.1 mm² for example, which means that the chip can be produced inexpensively, since only a small amount of semiconductor surface area (e.g. on a silicon substrate) is required. The thickness of a banknote may typically be 100 μm.

Exemplary embodiments of the invention are illustrated in the figures and are explained in more detail below.

In the figures:

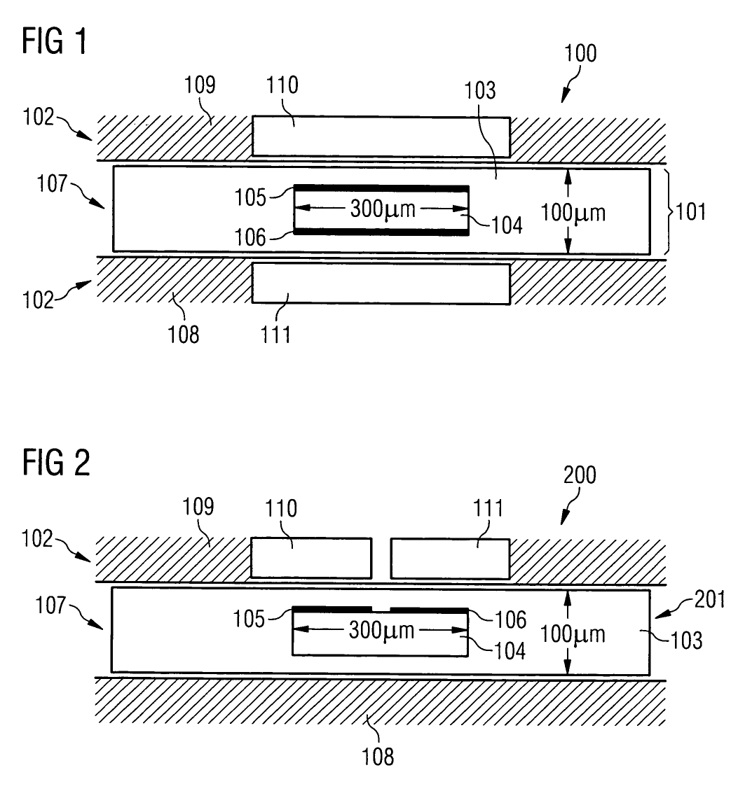

FIG. 1 shows a banknote identification system based on a first exemplary embodiment of the invention,

FIG. 2 shows a banknote identification system based on a second exemplary embodiment of the invention,

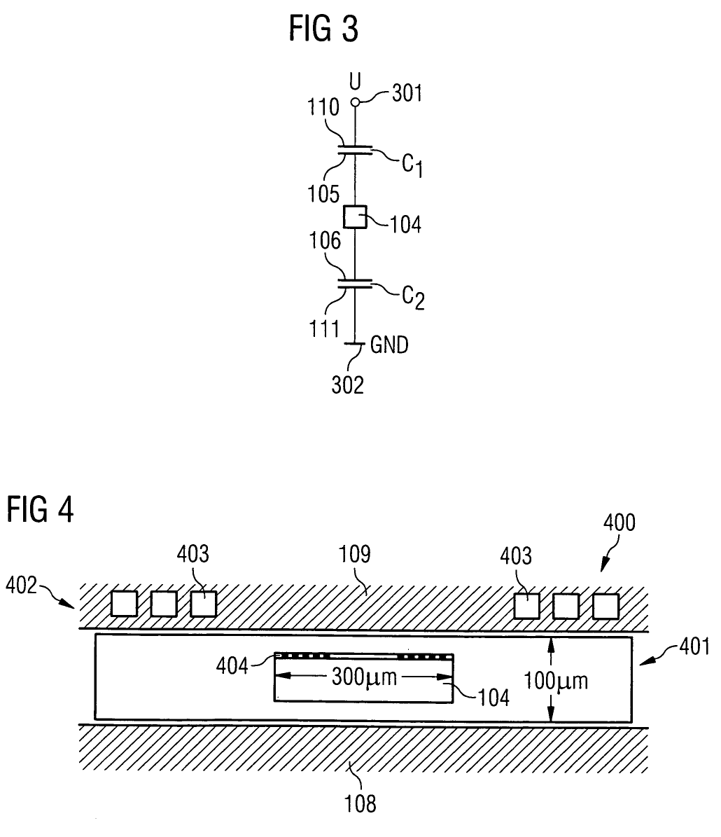

FIG. 3 shows a schematic equivalent circuit diagram from which the capacitive coupling for the banknote identification system from FIG. 1 can be seen,

FIG. 4 shows a banknote identification system based on a third exemplary embodiment of the invention.

Identical or similar components in different figures are provided with identical reference numerals.

The illustrations in the figures are schematic and are not to scale.

The text below describes a banknote identification system 100 based on a first exemplary embodiment of the invention with reference to FIG. 1.

The banknote identification system 100 contains a banknote 101 and a reader 102. The banknote 101 has a paper support 103 as a flexible, pliable and hard-wearing support element and has an electronic chip 104 in the paper support 103. The chip 104 has a circuit (not shown in FIG. 1) monolithically integrated in it. In addition, the chip 104 has a field coupling element monolithically integrated in it, said field coupling element being set up for capacitive interaction with an electromagnetic field and being coupled to the integrated circuit. The field coupling element or in other words an antenna, is formed from a first metalized layer 105 on a top face of the silicon chip 104 and from a second metalized layer 106 on a bottom face of the silicon chip 104.

The banknote 101 is inserted into a holding region 107 in a reader 102. The holding region 107 is provided as a gap between a base 108 and a cover 109 for the reader 102. The base 108 has a ground electrode 111 formed in it, and the cover 109 has a reading electrode 110 formed in it. The reading electrode 110 and the ground electrode 111 are arranged such that when the banknote 101 has been inserted they provide sufficiently good capacitive coupling to the banknote 101, particularly to the metalized layers 105, 106 on the banknote 101. In this case, the reading electrode 110 and the first metalized layer 105 clearly form a first capacitor, and the second metalized layer 106 and the ground electrode 111 form a second capacitor for the capacitive coupling.

The banknote 101 has a thickness of approximately 100 μm, and the chip 104 in the banknote 101 has a length of approximately 300 μm.

A memory device which forms part of the integrated circuit on the chip 104 stores the serial number of the banknote, the value of the banknote and a security code for checking of the authenticity of the banknote 101.

Since the chip 104 is insulated from the surroundings, an electric power (which is required for reading the signal and, in particular, provides the electromagnetic power which is required for operating the circuit on the chip 104) is input-coupled in capacitive fashion in FIG. 1. For this purpose, the banknote 101 is positioned between the two electrodes 110, 111.

In line with FIG. 1, the reading electrode 110 and the ground electrode 111 are part of the reader 102. Alternatively, the reading electrode 110 may also be in the form of an electrode of a mobile reader, and the ground electrode 111 may be incorporated in the base 108.

The reading apparatus 102 is set up to read information contained in the electronic chip 104 and contains an electromagnetic radiation source (not shown in FIG. 1) for emitting electromagnetic radiation to the metalized planes 105, 106 on the banknote 101 and also a detection device (not shown in FIG. 1) for detecting an electromagnetic signal emitted by the metalized planes 105, 106 on the banknote 101. In addition, the reading apparatus 102 contains an ascertainment device (not shown in FIG. 1) for ascertaining information contained in the chip 104 on the banknote 101 from electromagnetic signals emitted by the metalized planes 105, 106 on the banknote 101.

The banknote identification system 100 from FIG. 1 with the banknote 101 and the reader 102 clearly forms an arrangement comprising two capacitances, namely a first capacitance between reading electrode 110 and the top metalized layer 105 of the chip 104, and a second capacitance between the back's metalized portion 106 of the chip 104 and the ground electrode 111. Alternatively, the back's metalized portion 106 may also be omitted, in which case the second capacitance is formed from the electrically conductive substrate of chip 104 and the ground electrode 111. When a suitable alternating field with sufficient amplitude is applied, this sets up an electric voltage between the front of the chip and the back of the chip, this voltage being able to be used to generate the operating voltage for operating the integrated circuit on the chip 104.

FIG. 3 shows an equivalent circuit diagram 300 for the arrangement from FIG. 1.

FIG. 3 shows that the reading electrode 110 has been put at an electric operating potential 301, whereas the ground electrode 111 is at the electric ground potential 302. The reading electrode 110 and the first metalized layer 105 have a first capacitance C₁ formed between them, and the second metalized layer 106 and the ground electrode 111 have a second capacitance C₂ formed between them.

The setup of an operating voltage in the chip 104 may be implemented in similar fashion to that in conventional high frequency identification chips (RFID (Radio Frequency Identification Device) transponders). In line with the invention, the methods for interchanging the information between chip 104 and reader 102 may also be in a similar form to those in RFID technology.

It should be noted that in the case of the configuration shown in FIG. 1 the reader 102 contains both the base 108 and the cover 109, which form a slot 107 into which a banknote 101 can be inserted. Alternatively, a capacitive measuring system based on the invention may be formed from a banknote, a ground electrode integrated in a base and a reader which moves over the banknote. In line with this refinement, only the components above the banknote 101 in FIG. 1 are part of the reader.

The text below gives a few numerical examples to illustrate the relevant electrical variables. At a frequency of 13.65 MHz, the impedance of the two capacitances C₁, C₂ is 1.3 MΩ in each case. At a frequency of 900 MHz, the impedance of the two capacitances C₁, C₂ is 20 kΩ in each case. In line with current CMOS technology, a power of 140 μW is required on the chip at a frequency of 13.56 MHz and a power of 9.0 mW is required at a frequency of 900 MHz. The impedance of the chip is in the range between approximately 5 kΩ and 20 kΩ.

This estimate relates to a distance of 100 μm between the two electrodes 110, 111. At a greater distance, the voltage U required increases accordingly, i.e. even for a 900 MHz application it will barely be possible to have much greater reading distances than 1 mm. This is important in order for reading of the chip not to be able to take place unnoticed (e.g. through pockets or the like), which reduces the risk of deception.

A typical banknote has a thickness of 100 μm, see FIG. 1. As a chip dimension, a surface area of 0.1 mm² is typically required, which is advantageous for the demanded low price level, and a thickness of 40 μm is proposed. It is thus possible to keep the distance to the respective outer electrode below 100 μm.

The chip electrodes can be produced from the top metal layer 105 and the back's metalized portion 106. Depending on the doping of the silicon substrate for forming the silicon chip 104, the back's metalized portion 106 may also be omitted, in which case the material of the silicon substrate adopts the functionality of the second electrode for forming the second capacitance C₂. On account of the symmetrical design of the banknote 101, the orientation of the banknote during reading is of no significance, which increases operating convenience.

The chip 104 is provided with a memory device which has either a rewriteable memory (EEPROM) or a write-once memory (OTP). It is likewise possible to enable parts of an EEPROM just for single writing (e.g. by using “TOX fuses”).

The text below describes a banknote identification system 200 based on a second exemplary embodiment of the invention with reference to FIG. 2.

The banknote identification system 200 is formed from a banknote 201 and from a reader 202. The fundamental differences between the banknote identification system 200 and the banknote identification system 100 are described in more detail below.

First, in the refinement shown in FIG. 2, the reader 202 is provided independently of the base 108. In other words, in FIG. 2 a banknote 201 is placed onto an arbitrary base 108, and a reader 202 is arranged above it in such a way that capacitive coupling takes place between the metalized layers 105, 106 on the chip 104 and the reading and ground electrodes 110, 111.

Another important difference between the banknote identification system 200 and the banknote identification system 100 is that in the banknote identification system 200 both the first metalized layer 105 and the second metalized layer 106 are provided on the top of the chip 104. As FIG. 2 shows, the first metalized layer 105 is electrically decoupled from the second metalized layer 106. In addition, in FIG. 2 both the reading electrode 110 and the ground electrode 111 are contained in the cover 109 of the reader 202. When the banknote 201 has been inserted into the holding region 107, capacitive interaction takes place between the reading electrode 110 and the first metalized layer 105, on the one hand, and between the ground electrode 111 and the second metalized layer 106, on the other hand. Unwanted interactions between the reading electrode 110 and the ground electrode 111 or between the reading electrode 110 and the second metalized layer 106 or between the ground electrode 111 and the first metalized layer 105 can be suppressed using suitable shielding.

The text below describes a banknote identification system 400 based on a third exemplary embodiment of the invention with reference to FIG. 4.

The banknote identification system 400 implements inductive coupling between a banknote 401 and a reader 402.

The reader 402 differs from the reader 202 in that the reading of information or the communication with the chip 104 is effected using inductive coupling between a reading coil 403 in the reader 402 and a structured metalized layer as integrated coil 404.

In line with the variant from FIG. 4, it is thus possible to replace the coupling capacitor principle described with reference to FIG. 1 and FIG. 2 with coil coupling (i.e. inductive coupling). In this case, it is possible to put just one coil on the front (or optionally also just on the back) of the silicon chip 104 if said coil has an appropriate number of windings. This avoids the back's metalized portion of the chip 104 in FIG. 4.

In the case of the capacitive coupling shown in FIG. 1 and FIG. 2, the design of the reading and ground electrodes is significant. These electrode surface areas are each larger than the chip surface area, and therefore the electrode parts projecting over the chip deliver a background signal and thus make communication between reader and chip more difficult.

For this reason, the reading and ground electrodes are preferably split in the manner of a matrix with a respective suitably chosen base area. The individual matrix elements can be polled serially or in parallel. When a chip is detected on a matrix array, all other matrix elements can be turned off (e.g. temporarily) for the further communication.

Even in the case of inductive coupling (see FIG. 3), the coupling factor between the chip coil and the reading coil becomes all the less favorable the larger the reading coil becomes in comparison with the chip dimension. For this reason, a split into a plurality of reading coils is also advantageous in FIG. 4.

This document has cited the following publications:
[1] DE 196 30 648 A1
[2] WO 01/39137 A1
[3] DE 101 63 267 A1
[4] DE 29 19 649 A1

1-19. (canceled)

20. A note comprising:
a support element with the flexibility of paper;
an electronic chip on and/or in the support element;
a circuit monolithically integrated in the chip; and
a field coupling element monolithically integrated in the chip, configured to interact with an electromagnetic field and which is coupled to the integrated circuit, the field coupling element having a first metalized region and a second metalized region provided on opposite sides of the chip.

21. The note of claim 20, comprising wherein the field coupling element is an antenna.

22. The note of claim 20, comprising wherein the field coupling element is configured for capacitive interaction with an electromagnetic field.

23. The note of claim 22, comprising wherein the first metalized region is formed on the top or on the bottom of the chip.

24. The note of claim 22, comprising wherein the second metalized region is electrically decoupled from the first metalized region.

25. The note of claim 20, comprising wherein the field coupling element is configured for inductive interaction with an electromagnetic field.

26. The note of claim 25, comprising wherein the field coupling element has a metalized region.

27. The note of claim 26, comprising wherein the metalized region is formed as an inductance on one side of the chip.

28. The note of claim 20, comprising wherein the integrated circuit has a memory device.

29. The note of claim 28, comprising wherein the memory device is a nonvolatile memory device.

30. The note of claim 28, comprising wherein which the memory device is a rewritable memory device; or a write-once memory device.

31. The note of claim 28, comprising wherein the memory device stores at least one of the following pieces of information:
a serial number for the note;
a value for the note; or a security code.

32. The note of claim 20, comprising wherein the integrated circuit has at least one of the following components:
a cryptography module;
a rectifier circuit; or
a load modulator circuit.

33. The note of claim 20, comprising wherein the note is configured as one of a group consisting of:
a banknote;
a ticket;
a ski pass;
a betting slip;
a share; or a bill.

34. A reading apparatus for reading information contained in an electronic chip on a note, comprising:
a holding device for holding the note;
an electromagnetic radiation source for emitting electromagnetic radiation to a field coupling element on the note, wherein the field coupling element is monolithically integrated in the chip on the note;
a detection device for detecting an electromagnetic signal emitted by the field coupling element on the note; and
an ascertainment device for ascertaining information contained in the chip on the note from the electromagnetic signal emitted by the field coupling element on the note.

35. The reading apparatus of claim 34, comprising a reading electrode and a ground electrode configured to have the field coupling element on the note inserted between them.

36. The reading apparatus of claim 34, comprising a reading coil in whose surrounding area it is possible to place the note's field coupling element.

37. The reading apparatus of claims 34, comprising wherein the electromagnetic radiation source is configured to emit electromagnetic radiation in the high frequency range or in the ultra high frequency range.

38. A note identification system comprising:
a note comprising:
a support element with the flexibility of paper;
an electronic chip on and/or in the support element;
a circuit monolithically integrated in the chip; and
a field coupling element monolithically integrated in the chip, configured to interact with an electromagnetic field and which is coupled to the integrated circuit, the field coupling element having a first metalized region and a second metalized region provided on opposite sides of the chip; and
a reading apparatus for reading information contained in the electronic chip on the note.

39. The system of claim 38, wherein the reading apparatus further comprises:
a holding device for holding the note;
an electromagnetic radiation source for emitting electromagnetic radiation to the field coupling element on the note, wherein the field coupling element is monolithically integrated in the chip on the note;
a detection device for detecting an electromagnetic signal emitted by the field coupling element on the note; and
an ascertainment device for ascertaining information contained in the chip on the note from the electromagnetic signal emitted by the field coupling element on the note.

40. A reading apparatus for reading information contained in an electronic chip on a note, comprising:
means for holding the note;
means for emitting electromagnetic radiation to a field coupling element on the note, wherein the field coupling element is monolithically integrated in the chip on the note;
means for detecting an electromagnetic signal emitted by the field coupling element on the note; and
means for ascertaining information contained in the chip on the note from the electromagnetic signal emitted by the field coupling element on the note.

41. A financial note comprising:
a support element with a flexibility of paper;
an electronic chip on in the support element;
a circuit monolithically integrated in the chip;
a field coupling element monolithically integrated in the chip, configured to interact with an electromagnetic field and which is coupled to the integrated circuit, the field coupling element having a first metalized region and a second metalized region provided on opposite sides of the chip; and
a memory device storing a value for the financial note.

42. The note of claim 41, comprising:
wherein the memory device is configured to store a number corresponding to the financial note; and a security code associated with accessing information on the financial note.

43. The note of claim 41, further comprising:
a cryptography module.
